(19) United States
(12) Patent Application Publication
(10) Pub. No.: US 2022/0193957 A1
(43) Pub. Date: Jun. 23, 2022

(54) APPARATUS FOR FORMING AN ARTICLE

(71) Applicants: Heidi Kujawa, Sherman Oaks, CA (US); Michael Kujawa, Ingleburn (AU)

(72) Inventors: Heidi Kujawa, Sherman Oaks, CA (US); Michael Kujawa, Ingleburn (AU)

(21) Appl. No.: 17/131,019

(22) Filed: Dec. 22, 2020

(51) Int. Cl. B29B 17/00; B29B 17/04

(52) U.S. Cl. CPC B29B 17/0036; B29B 17/0412

(57) ABSTRACT

An apparatus for forming a plastic article is disclosed, comprising at least one intake conveyor to receive a plurality of plastic material and transfer the plurality of plastic material to at least one shredder to shred the plurality of plastic material. At least one stage conveyor transfers plastic from the at least one shredder to at least one load conveyor to transfer shredded plastic to at least one weigh apparatus. At least one boiler system provides pressure and heat to at least one blocker cell to process the shredded plastic to a block or similar article. At least one offtake conveyor receives and expels the block.

### TECHNICAL FIELD

The embodiments generally relate to apparatuses and methods for forming articles made of thermoplastics whereby the thermoplastics serve as the binding agent.

### BACKGROUND

Large volumes of waste inundate both the developed and undeveloped communities throughout the world. In the developed world, many governments have organized waste mitigation solutions to collect, process, and manage large volumes of waste produced by members of the community. In particular, efforts to recycle plastics and paper waste have focused on processes wherein recyclable materials are sorted into various types, and controlled proportions are utilized to produce recycled products.

Developing nations and communities thereof may have no organized means for collecting recyclable materials and transforming the recyclable materials into a usable item. Lack of waste management infrastructure and specifically collection and sorting materials capabilities may compound the proliferation of plastic waste in the environment overall.

In the current arts, there are seven types of plastic including:
Code 1: Polyethylene Terephthalate (PET or PETE);
Code 2: High Density Polyethylene (HDPE);
Code 3: Vinyl (Polyvinyl Chloride or PVC);
Code 4: Low Density Polyethylene (LDPE);
Code 5: Polypropylene (PP);
Code 6: Polystyrene (PS); and
Code 7: Other.

Of these seven types of plastics, generally only Code 1: Polyethylene Terephthalate (PET or PETE) and Code 2: High Density Polyethylene (HDPE) are sorted and recycled and the remaining types, referred to in the arts as mixed plastics, are landfilled or incinerated. This sorting system is generally accepted in the industry. However, tightly controlled sorting is expensive and is a significant cost component in current recycling processes. The current arts do not provide a convenient system for utilizing mixed plastics to produce a usable item therefrom.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Embodiments described herein provide an apparatus for forming a plastic article, comprising at least one intake conveyor to receive a plurality of plastic material and transfer the plurality of plastic material to at least one shredder to shred the plurality of plastic material. At least one stage conveyor transfers plastic from the at least one shredder to at least one load conveyor to transfer shredded plastic to at least one weigh hopper system. The system material handling and weigh station configuration/placement may vary to support the constraint of the user's operation. At least one boiler system provides pressure and heat to a customizable and interchangeable compression chamber of at least one blocker cell to process the shredded plastic to a block. At least one offtake conveyor receives and expels the block or similar article.

The system permits the repurposing and reusing of various types of plastic using a steam-based compression process. The system is operable to form an article using various types of discarded plastics. The system is constructed to be modular, customizable, and mobile to permit the easy transportation and deployment of the system in various locations. Further, the system may be modular to allow for expansion and compression of size based on the volume of plastic which is processed through the system. The system also allows for the production of various articles which may be developed or are currently available. Monitoring control software is provided in operable communication with a controller of the system to permit an operator to monitor operating conditions, control operational settings, and the like.

In one aspect, a plurality of sensors are positioned to monitor the blocker cell, wherein each of the plurality of sensors are in operable communication with the controller.

In one aspect, the shredder is configured to shred plastic to a size of about 10-15 mm.

In one aspect, the shredder is configured to handle variable processing speeds to address variations in plastic volume requirements.

In one aspect, the load conveyors link system components to move materials between programmed distribution points.

In one aspect, the weigh hopper system weighs the shredded plastic to a programmed mass density.

In one aspect, a wastewater trough is positioned under the blocker cell to collect wastewater therefrom.

In one aspect, a robotic palletizer is used to position and arrange the blocks on a pallet.

In one aspect, a dry rack permits drying of the blocks.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a side elevation view of the community blocker apparatus, according to some embodiments;

FIG. 2 illustrates a side elevation view of an example industrial blocker apparatus, according to some embodiments;

FIG. 3 illustrates a top plan view of the apparatus and internal components, according to some embodiments;

FIG. 4A illustrates a front elevation view of the blocker cell, according to some embodiments;

FIG. 4B illustrates a side elevation view of the blocker cell, according to some embodiments;

FIG. 5A illustrates the blocker cell in a horizontal configuration, according to some embodiments;

FIG. 5B illustrates the blocker cell in a horizontal configuration, according to some embodiments;

FIG. 6 illustrates a perspective view of the containerized apparatus, according to some embodiments; and

FIG. 7 illustrates a perspective view of the containerized apparatus, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

In general, the system provided herein relates to a system for repurposing and/or reusing various types of plastic using a steam-based compression process. The system is operable to form an article using the repurposed plastics without resulting in degradation of the polymers. The system is constructed to be modular, customizable, and mobile to permit the easy transportation and deployment of the system in various locations. Further, the system may be modular to allow for expansion and compression of size based on the volume of plastic, which is processed through the system. The system also allows for the production of various articles which may be developed or are currently available. For example, a large town may require a large configuration compared to a single business, which may produce or create a limited amount of plastic waste. Monitoring control software is provided in operable communication with the system to permit an operator to monitor operating conditions, control operational settings, and the like.

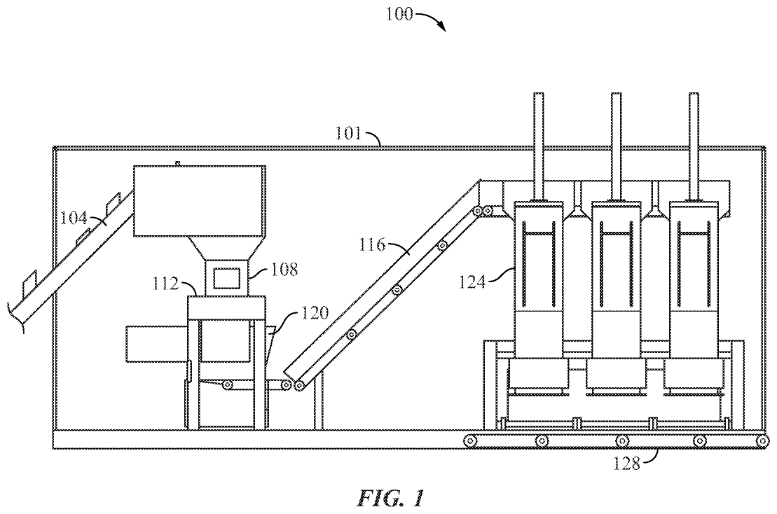

FIG. 1 illustrates an exemplary apparatus 100 for forming an article and specifically shows a mobile community blocker apparatus 101. The decontamination station may be utilized by operators for the removal of residual contaminants before entering the load conveyor 116. An intake conveyor 104 loads plastic from a bale breaker or bale preparation station into a shredder 108 configured to shred plastics into suitably sized strips of about 10-15. A weigh apparatus 120 weighs the plastic to a programmed mass density and feeds the plastic, via the load conveyor 116, to the blocker cell 124. The blocker cell 124 processes the shredded plastic into blocks, which may be utilized for various purposes. An offtake conveyor 128 transfers the blocks from the blocker cell 124 out of the apparatus 100.

In some embodiments, the shredder 108 operates to handle variable processing speeds to address variations in plastic volume requirements. The shredder 108 may be in operable communication with a controller to allow an operator to vary the speed of the shredder 108 and ensure a steady flow of plastic into and out of the shredder 108.

In some embodiments, the load conveyor 116 is configured in an inclined position and uses a cleated belt to facilitate the movement of the material to the designated blocker cell 124.

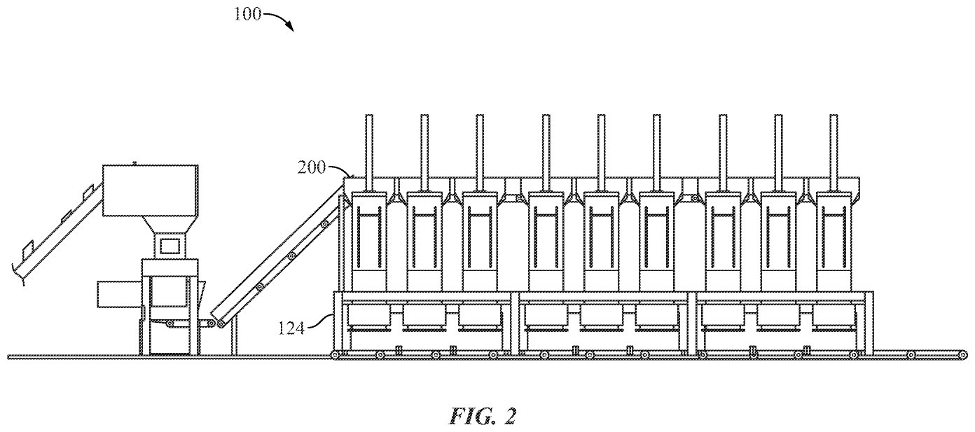

FIG. 2 illustrates an exemplary depiction of the industrial blocker apparatus 200 which is configured to output a high volume of plastic compared to the community blocker apparatus 101 illustrated in FIG. 1. The industrial blocker apparatus 200 operates using similar processes having components configured to process a larger amount of plastic. For example, the industrial blocker apparatus may comprise more blocker cells 124 to simultaneously process a higher volume of plastic strips. The community blocker apparatus comprises three blocker cells 124 while the industrial blocker apparatus 200 comprises nine or more blocker cells 124. One skilled in the arts will readily understand that the number of blocker cells 124 may be changed in view of the specific application or location of the apparatus 100.

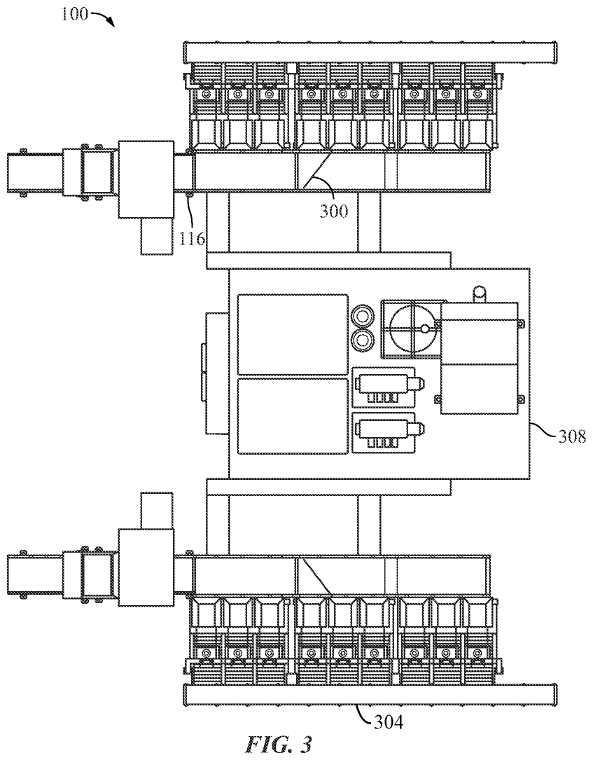

FIG. 3 illustrates a top plan view of the apparatus 100 to illustrate internal components of the system. The load conveyor 116 comprises a guide arm 300 which may pivot to direct the flow of plastic to the blocker cell 124. The guide arm 300 may be in communication with a controller to operate a pivot to allow an operator to selectively pivot the guide arm to a suitable position during use. A wastewater trough 304 captures wastewater and is positioned under each blocker cell and offtake conveyor. This allows for wastewater to be captured via pump or gravity depending on the configuration or location of the apparatus 100. A boiler system 308 generates high-pressure steam to form the blocks produced by the apparatus 100. The boiler system 308 comprises a water filtration system, a vent system, and fuel tanks to generate the high-pressure steam.

In some embodiments, the system permits wastewater recapture. In such, the wastewater is captured and filtered for reuse. In another embodiment, the system recaptures steam for future use.

The system is configurable based on the energy resources available at the location of the system. For example, the system may operate using propane, natural gas, or electric power.

In some embodiments, the wastewater trough 304 is configured to resist corrosion under constant moisture. At least one drainage point is provided to drain wastewater from the trough 304. The number of drainage points is dependent on the number of blocker cells from which the trough 304 gathers wastewater.

In some embodiments, the steam supply lines feed the needles and the compression chamber. Return steam supply lines are provided to collect and return reclaimed water to a retention tank for reuse in future cycles. Each steam supply line includes separate valves with individual control by the controller.

In some embodiments, the steam supply to the needles do not include return steam supply lines.

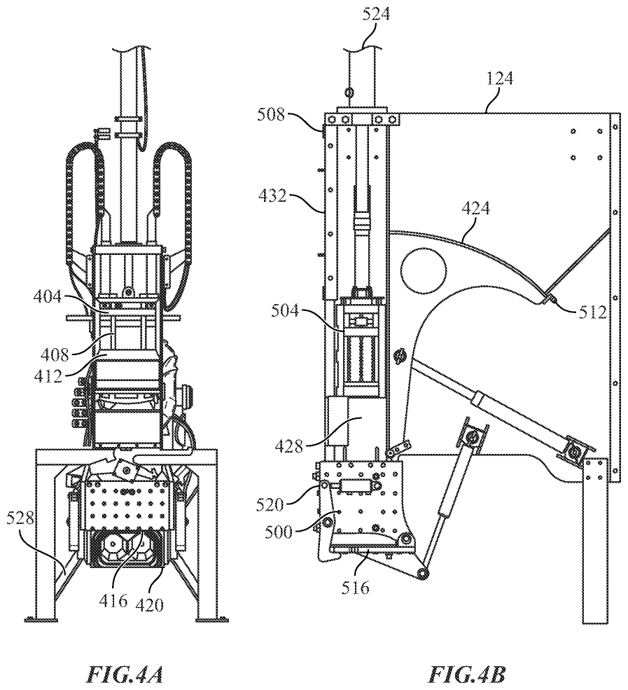

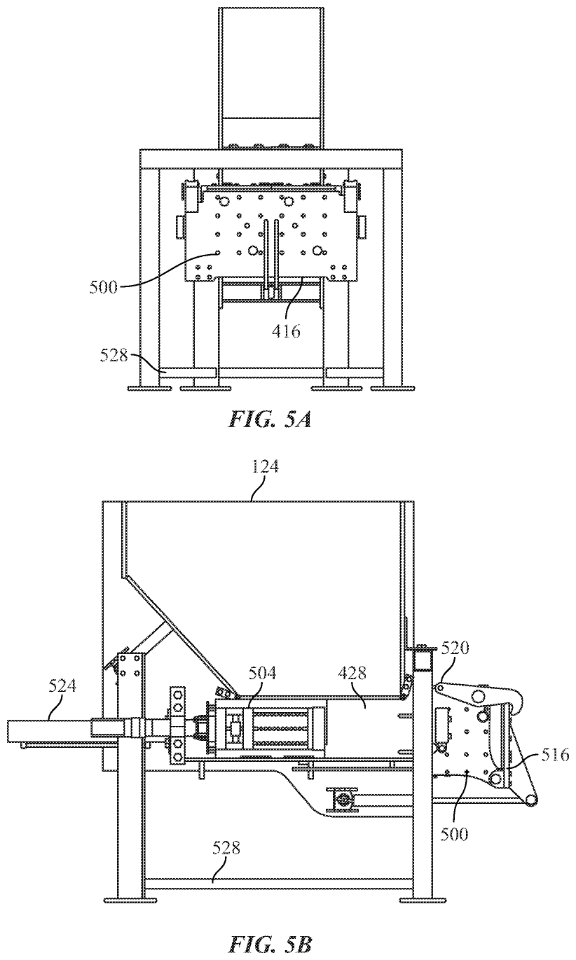

FIG. 4A and FIG. 4B illustrate the blocker cell 124 comprising a hydraulic system having a top ram, delivery press ram, door ram, and door lock ram. The top ram may include sensors inside or outside of the ram. The strength of each ram may be variable using a controller depending on the specific purpose of the apparatus. Shown in FIG. 4, a needle carriage 404 is positioned within the delivery chute 428 and comprises a needle cylinder mount plate to provide location of steam distribution the top plate via a manifold system. A needle mount block includes attachment points for needles on top of the block. The needle mount block may be customizable to adjust as required by the compression chamber. The top ram applies vertical pressure, via the hydraulic system 524 to form the block. The needles 408 comprise a hollow core and are constructed to avoid sticking to the plastic under high pressure. The needles 408 are in operable communication with the controller via sensors monitoring operating conditions. A top press plate 412 is constructed to conduct temperature quickly without compromising their stability and without sticking to the plastic at high pressure. Sensors are positioned to monitor the top press plate 412 and are in operable communication with the controller. A compression chamber 416 provides a chamber wherein the plastic is compressed at high pressure. The compression chamber 416 is comprised of a plurality of panels (at least one hollow-core block and one cap per panel) to provide a shape to the blocks. The panels are hermetically sealed from water and air and can withstand high pressures experienced within the chamber. A bottom door 420 comprises a hollow block and a cap plate. The bottom door 420 is hinged to allow the bottom door 420 to open and shut to allow the block to drop from the compression chamber 416 once the block is formed therein. A plurality of sensors are positioned on the bottom door 420 and are in operable communication with the controller. A material press guide 424 (see FIG. 5) is provided with a hinge and presses plastic material into the chute for compression within the compression chamber 416. In the closed position, the material press guide 424 forms the back wall of the delivery chute 428 (see FIG. 4B), which delivers the plastic to the compression chamber 416. A plurality of sensors are positioned within the delivery chute 428 and are in operable communication with the controller. A maintenance door 432 provides an access for maintenance of the blocker cell. The maintenance door 432 (see FIG. 4B) forms the front wall of the delivery chute 428.

In some embodiments, the compression chamber 416 is detachable to permit the modification of the blocker cell to produce multiple articles with the same system. In such, the system may be provided with accessory components to produce the various articles.

As described hereinabove and illustrated in FIG. 5, a plurality of sensors are positioned within the blocker cell and throughout the collective system to monitor the placement of material, position of moving parts, control factors, and safety factors.

While the blocker cell is illustrated herein in a vertical configuration, the blocker cell 124 may be installed horizontally with minor component adjustments as illustrated in FIG. 5A and FIG. 5B.

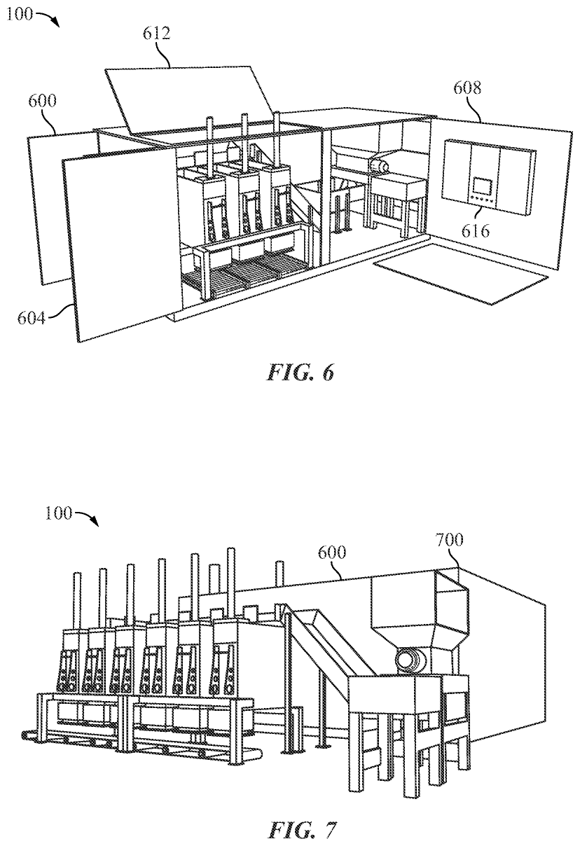

FIG. 6 and FIG. 7 illustrate perspective views of the apparatus 100 provided within a container 600. As described hereinabove, the apparatus 100 may be contained within one or more standard ISO shipping containers and the various sizes thereof. In such, the apparatus 100 may be transferred via railway, vehicle, or ship and combinations thereof to the location of use. This allows the apparatus 100 to be readily deployed in various settings. A plurality of access doors 604, 608, 612 are provided to allow the system to be accessible and operational when positioned in the operating location. For example, access door 604 may be positioned to permit access to the blocker cells. Access door 608 may open to permit access to the controller 616 and control interface. FIG. 7 illustrates the industrial blocker apparatus which may comprise a boiler container 700 separate from, but in communication with, the blocker cells, intake hopper, intake conveyor, and likewise components of the apparatus.

In some embodiments, the system is modular to account for water and energy availability in the region within which it is deployed.

In some embodiments, the system may be provided in two or more configurations including a small configuration (also referred to herein as “community blocker” and “first configuration”) and a large configuration (also referred to herein as “industrial blocker” and “second configuration”) system. The small configuration is designed for small recycling operations, small community projects, disaster relief and clean-up, and to allow for the system to be mobile and deployable in various environments. For example, the small configuration of the system may be packaged in two ISO standard shipping containers (20 ft to 40 ft in length) to facilitate easy transport and safety, wherein the first of the two shipping containers includes the operational components described herein and the second shipping container houses the boiler system. The large configurations are intended to be floor mounted in a desired position and are not mobile. The large configuration is modular and scalable to accept larger output requirements.

In some embodiments, the apparatus comprises a robotic palletizer to aggregate and organize the blocks onto a pallet.

In some embodiments, the apparatus comprises a drying rack constructed of a wire mesh to allow drying of the blocks once they are formed.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An apparatus for forming a plastic article, comprising:
at least one intake conveyor to receive a plurality of plastic material and transfer the plurality of plastic material to at least one shredder to shred the plurality of plastic material;
at least one stage conveyor to transfer plastic from the at least one shredder to at least one load conveyor to transfer shredded plastic to at least one weigh apparatus;
at least one boiler system to provide pressure and heat to at least one blocker cell to process the shredded plastic to a block; and
at least one offtake conveyor to receive and expel the block.

2. The apparatus of claim 1, wherein the shredder is configured to shred plastic to a size of about 10-15 mm.

3. The apparatus of claim 2, wherein the shredder is configured to handle various processing speeds to address variations in plastic volume requirements.

4. The apparatus of claim 1, wherein the load conveyors link system components to move materials between programmed distribution points.

5. The apparatus of claim 1, wherein the weigh apparatus weighs the shredded plastic to a programmed mass density.

6. The apparatus of claim 1, further comprising a wastewater trough positioned under the blocker cell to collect wastewater therefrom.

7. The apparatus of claim 6, further comprising a robotic palletizer to position and arrange the blocks on a pallet.

8. The apparatus of claim 7, further comprising a dry rack to permit drying of the blocks.

9. The apparatus of claim 1, wherein the apparatus is configured as a community blocker apparatus.

10. The apparatus of claim 1, wherein the apparatus is configured as an industrial blocker apparatus.

11. An apparatus for forming a plastic article, comprising:
at least one intake conveyor to receive a plurality of plastic material and transfer the plurality of plastic material to at least one shredder to shred the plurality of plastic material;
at least one stage conveyor to transfer plastic from the at least one shredder to at least one load conveyor to transfer shredded plastic to at least one weigh apparatus;
at least one boiler system to provide pressure and heat to a compression chamber of at least one blocker cell to process the shredded plastic to a block, the blocker cell comprising;
at least one hydraulic;
at least one needle carriage;
at least one needle;
at least one top press plate;
at least one compression chamber;
at least one bottom door;
at least one material press guide;
at least one maintenance door; and
at least one delivery chute; and
at least one offtake conveyor to receive and expel the block.

12. The apparatus of claim 11, further comprising a plurality of sensors positioned to monitor the blocker cell, wherein each of the plurality of sensors are in operable communication with a controller.

13. The apparatus of claim 12, wherein the shredder is configured to shred plastic to a size of about 10-15 mm.

14. The apparatus of claim 13, wherein the shredder is configured to handle various processing speeds to address variations in plastic volume requirements.

15. The apparatus of claim 12, wherein the load conveyors link system components to move materials between programmed distribution points.

16. The apparatus of claim 12, wherein the weigh apparatus weighs the shredded plastic to a programmed mass density.

17. The apparatus of claim 12, further comprising a wastewater trough positioned under the blocker cell to collect wastewater therefrom.

18. The apparatus of claim 17, further comprising a robotic palletizer to position and arrange the blocks on a pallet.

19. The apparatus of claim 18, further comprising a dry rack to permit drying of the blocks.

20. An apparatus for forming a plastic article, comprising:
at least one intake conveyor to receive a plurality of plastic material and transfer the plurality of plastic material to at least one shredder to shred the plurality of plastic material;
at least one stage conveyor to transfer plastic from the at least one shredder to at least one load conveyor to transfer shredded plastic to at least one weigh apparatus;
at least one boiler system to provide pressure and heat to a compression chamber of at least one blocker cell to process the shredded plastic to a block, the blocker cell comprising;
at least one hydraulic to provide compression to a compression chamber via a needle carriage, a needle, and a top press plate;
at least one bottom door to expel the block;
at least one material press guide forming the back wall of the delivery chute;
at least one maintenance door forming the front wall of the delivery chute;
at least one delivery chute to deliver the plurality of plastic material to the compression chamber; and
at least one offtake conveyor to receive and expel the block.
